(19) United States
(12) Patent Application Publication
(10) Pub. No.: US 2008/0212490 A1
(43) Pub. Date: Sep. 4, 2008

(54) Method of Setting Up Connections in a Communication Environment, Communication System and Contact Elemenet for Same

(75) Inventors: Michael Greve, Karlsruhe (DE); Pierre-Alain Cotte, Amberg (DE); Frank Schueler, Karlsruhe (DE); Matthias Greve, Karlsruhe (DE); Zong Hyeck An, Karsruhe (DE)

Correspondence Address: DARBY & DARBY P.C., P.O. BOX 770, Church Street Station, New York, NY, 10008-0770, US

(73) Assignee: comBOTS Products GmbH & Co. KG, Karlsruhe (DE)

(21) Appl. No.: 10/597,588

(22) PCT Filed: Jan. 31, 2005
(86) PCT No.: PCT/EP05/00938

§ 371 Date: Mar. 27, 2008

Related U.S. Application Data
(60) Provisional application No. 60/574,489, filed on May 26, 2004.
(60) Provisional application No. 60/584,698, filed on Jul. 1, 2004.
(60) Provisional application No. 60/635,535, filed on Dec. 13, 2004.
(60) Provisional application No. 60/642,850, filed on Jan. 11, 2005.
(60) Provisional application No. 60/586,469, filed on Jul. 8, 2004.

(30) Foreign Application Priority Data
Jan. 30, 2004 (EP) 04002154.5
May 21, 2004 (EP) 04012120.4
Jul. 8, 2004 (DE) 10 2004 033 164.2
Aug. 16, 2004 (DE) 10 2004 039 697.3
Oct. 26, 2004 (DE) 10 2004 052 071.2
Dec. 11, 2004 (DE) 10 2004 059 748.0
Jan. 11, 2005 (DE) 10 2005 001 329.5

(51) Int. Cl. H04L 12/28

(52) U.S. Cl. 370/254

(57) ABSTRACT

A method of setting up a connection in a communication environment controlled by a communication system between a first node allocated to a first contact and a second node allocated to a second contact includes the steps of providing a contact element within the first node for the first contact, the contact element having graphic and functional properties and graphically representing the second contact, an unambiguous identification and contact data being allocated to the contact element; accessing the contact data using a program and setting up a first connection from the first node to the communication system; checking within the communication system using the unambiguous identification whether the contact element is approved by the communication system for the setting-up of connections; and setting up a second connection to the second node depending on a result of the checking.

### CROSS-REFERENCE TO PRIOR APPLICATIONS

This is a U.S. national phase application of International Patent Application No. PCT/EP2005/000938, filed Jan. 31, 2005, and claims the benefit of European Patent Application EP 04002154.5, European Patent Application EP 04012120.4, U.S. Provisional Patent Application No. 60/574,489, U.S. Provisional Application No. 60/584,698, U.S. Provisional Application No. 60/586,469, German Patent Application DE 10 2004 033 164.2, German Patent Application DE 10 2004 039 697.3, German Patent Application DE 10 2004 052 071.2,

The present invention lies in the field of communication generally and is directed towards the setting-up of a connection in a communication environment controlled by a communication system between a first node which is allocated to a first contact and a second node which is allocated to a second contact. In particular the present invention is directed towards internet-supported communication in which users act as contact and communication partners. The invention is also directed towards applications in which an individual user contacts web servers or web services of service providers in order to use services there.

### BACKGROUND

Various communication systems, communication applications or also communication programs are known via which a user of a communications network such as for example the internet can communicate with other users. Thus one user contacts the other user. Therefore every user can be considered a contact and both users can be considered contact partners. Examples of such communication applications are e-mail applications, fax applications or also file-sharing programs via which respectively e-mails or faxes or files can be exchanged between contacts (users). These applications run e.g. on a local PC which is connected to the communication network direct or as service-requesting device (client) via a service PC (server). Or the application runs for the most part at least on the service PC (server) which the local PC (client) accesses.

In order to contact other users or service providers it already known to use contact elements in the form of a so-called “Call Me Button”. These are graphic buttons which are displayed on web pages in internet presences and offer the user a connection set-up to a contact partner by clicking the mouse, in particular via e-mail. In the simplest case a so-called mailto link is also offered as a contact element. Clicking the mouse on the contact element starts an e-mail program on the user's PC, wherein the contact address of the service provider is entered as receiver address in the “To” field of the e-mail. Optionally, an entry is also automatically made in the “Subject” field. The user can then immediately compose and send an e-mail.

These known solutions are essentially limited to such automatic entry or completion functions and can also be applied only to one specific type of communication, namely communication by e-mail. However, it would also be desirable to have contact elements which can be used in as many communication types and networks as possible. A method and a system would also be desirable with which any connections can be made between contacts, even those which can be used not only for a communication in the narrower sense, but also for other applications, such as e.g. for file-sharing or for using online services. The connection set-up should also be protected against misuse. The known communication elements which are incorporated into the internet presence as a button or else as a link can be used by anyone via a browser. And the contact elements can even be copied by anyone into other web presences, which is not necessarily desired by the provider.

### SUMMARY OF THE INVENTION

Therefore, an object of the present invention is to overcome the above-named disadvantages and to propose an improved method for setting up contact connections and to propose a communication system and a contact element for same.

The present invention provides a method for setting up a connection in a communication environment controlled by a communication system between a first node which is allocated to a first contact and a second node which is allocated to a second contact. The following steps are proposed:

Within the first node a contact element is provided for the first contact which graphically represents the second contact and to which an unambiguous identification and contact data are allocated. Then the contact data are accessed by means of a program and the connection set up from the first node to the communication system. It is then checked within the communication system with the help of the unambiguous identification of the contact element, whether the contact element is an element allowed by the communication system for the setting-up of connections. The connection to the second node is then set up depending on the result of the check.

A method is thus proposed by these measures in which an intelligent contact element is used which is unique by virtue of its identification and it is unambiguously checked by the communication system so that only allowed connections result. The connection set-up with such a contact element thus obtains an exclusivity which protects against unintended or even unlawful uses. The contact providing the contact element, i.e. the provider, can be sure that there is no misuse. The contact receiving this contact element, i.e. the receiver, can be sure that he is receiving an exclusive right to connect to the provider and/or use his services. The unambiguous identification of every contact element has a corresponding article or serial number which means that, with every contact element specific properties and third-party rights, in particular licensing rights, copyright, picture rights and associated use, enjoyment and/or marketing rights, can also be connected. Proper use is thus monitored at all times.

Moreover, according to the coordinated claims a further communication system for controlling the set-up of such a connection is proposed as well as a contact element with which the connection set-up can be carried out.

The communication system is equipped with the following system components:

With a data-processing device which produces contact elements which each graphically represent one contact when there is another contact, in the form of files, wherein the data-processing device allocates each contact element an unambiguous identification and contact data. Also with an administration device which provides for the first contact a contact element which graphically represents the second contact and to which unambiguous identification and contact data are allocated. Also with computation means which, using the unambiguous identification of the contact element, check whether the contact element is an element allowed by a communication system for the setting-up of connections. And with control means which control the set-up of the connection from the first node to the communication system and onward to the second node.

The proposed contact element contains at least one graphic element for the representation on a display, in particular desktop, of a terminal. The contact element also contains functional elements which comprise an unambiguous identification which indicates that the contact element is allowed for the setting-up of connections in the communication system. The functional elements of the contact element also comprise contact data for the setting-up of the connection to the second node.

The proposed method, the system and the contact element itself can be used in many different ways for any type of establishing contact and communication.

Particularly advantageous versions of the invention result from the dependent claims:

Accordingly it is advantageous if the contact data contain at least details about services and/or functions, in particular communication services and/or functions which are provided by the second contact for the first contact, and if the details contained in the contact data are tested in the communication system, wherein, depending on the result of the test, the communication functions or services for use by the first contact are cleared. It is thus ensured that only services and functions which the provider has released by defining the contact element can be used. The supplied contact elements are provided e.g. for specific contacts, in particular for preferred and/or canvassed users. When creating the contact elements the provider can e.g. predetermine the properties of the contact elements in many different ways. For example he can also define the number and the extent of the provided services and functions related on an individual basis to suit the respective user. Thus the user is granted specific rights, determined via the contact element, for access to services and/or functions. Exclusive user groups can be formed, such as e.g. particular customer groups which receive so-called ServiceBots, or in-house groups which receive so-called CorporateComBots.

The first contact is preferably a user of the communication system to whom a terminal is allocated which is covered by the first node. The program is a user program which the user runs via his terminal in order to set up contact connections with other contacts via the communication system, wherein the contact element is provided as program object for the program, in particular in the form of a file or of a library. The contact element is defined by these measures as a program object which is tailored to the user program. The user program can comprise e.g. standard applications, such as, say, browser or clients for e-mail or instant messaging. However, the user program may also have been generated specially and exclusively only for the users of the communication system.

In this connection it is particularly advantageous if the second contact is a service provider and if the details contained in the contact data are predetermined by the service provider. The second node comprises a PC, in particular a server which is connected to the communication system and which is allocated to the service provider. Thus by these measures a connection between the user and a machine (PC, server) is created, wherein on the user's side the machine—just like a contact partner—is also represented by a graphic element. In this connection the contact element is preferably displayed as a graphic element on the user's terminal, wherein the graphic layout and/or animation of the element is predetermined by the service provider.

It is particularly advantageous if several contact elements which are allocated to various service providers are provided to the user for selection, and if the contact element selected by the user is installed on the user's terminal by a drag & drop operation on the display, in particular on the desktop of his terminal. This clearly simplifies operability. The user can simply click on and install the desired contact elements using drag & drop.

It is also advantageous if the first contact is a first user and if the second contact is a second user of the communication system to each of which a terminal is allocated, which is comprised of the first node or the second node, wherein the contact element is provided to the first user by the second user. The program is a user program which is installed at least on the first user's terminal and is run by the first user, in order to set up contact connections with the second user via the communication system, wherein the contact element is provided as a program object for the program, in particular in the form of a file or a library. These measures make it possible for every user to define contact elements and make them available to other users, such as e.g. preferred contact partners.

It is also particularly advantageous if the details contained in the contact data are provided with parameters which define graphic and/or functional properties of the contact element, in particular properties for a graphic layout, an animation, a period of validity and/or an intended use of the contact element. The partly providing contact (service provider or offering user) can create contact elements in many different ways and offer them to the desired contact partners.

### BRIEF DESCRIPTION OF THE DRAWINGS

In the following description of preferred embodiments, reference is made to the attached Figures which show the following:

FIG. 1 shows the representation of a connection in the form of a two-point contact connection in which the method according to the invention is applied and in which contacts are represented on the desktop by graphic elements, so-called ComBots;

FIG. 2 shows schematic representations of further variants of contact connections, in particular multipoint contact connections in which the method according to the invention is applied;

FIG. 3a shows the representation of a system architecture for managing contacts and for establishing contact connections by means of the method according to the invention integrating ComBots;

FIG. 3b shows the schematic representation of the logical structure of a two-point contact connection;

FIG. 4a shows the structure and the sequence for a method according to the invention in which a user accesses the so-called ServiceBots of service providers in order to establish contact and to use associated services;

FIG. 4b shows a flowchart of the process sequence according to FIG. 4a;

FIG. 5 shows the data structure of a ServiceBot according to the invention;

FIG. 6 shows the logical structure and the sequence of the method for the production, management and use of the ServiceBots;

FIG. 7 shows a part-section from the logical structure and the sequence of the method for the production, modification and destruction of ServiceBots;

FIG. 8 shows the principle of the sequence for allocating the ComBots according to the invention, in particular ServiceBots, from a supplying entity (service provider) to a target entity (user);

FIG. 9 shows the logical structure of a providing entity;

FIGS. 10a-c show various versions for allocating ComBots, in particular ServiceBots;

FIG. 11 shows the target entity in connection with a called communication entity which is formed as webserver of a service provider;

FIG. 12 shows the sequence of a stepwise allocation of ComBots, in particular ServiceBots;

FIG. 13 shows an invitation e-mail for the offering and provision of ComBots, in particular ServiceBots;

FIG. 14 shows the arrangement of ComBots in the form of ServiceBots on the desktop of a user PC; and

FIG. 15 shows the collection of ComBots in a so-called ComBotarium.

### DETAILED DESCRIPTION OF PREFERRED EMBODIMENTS

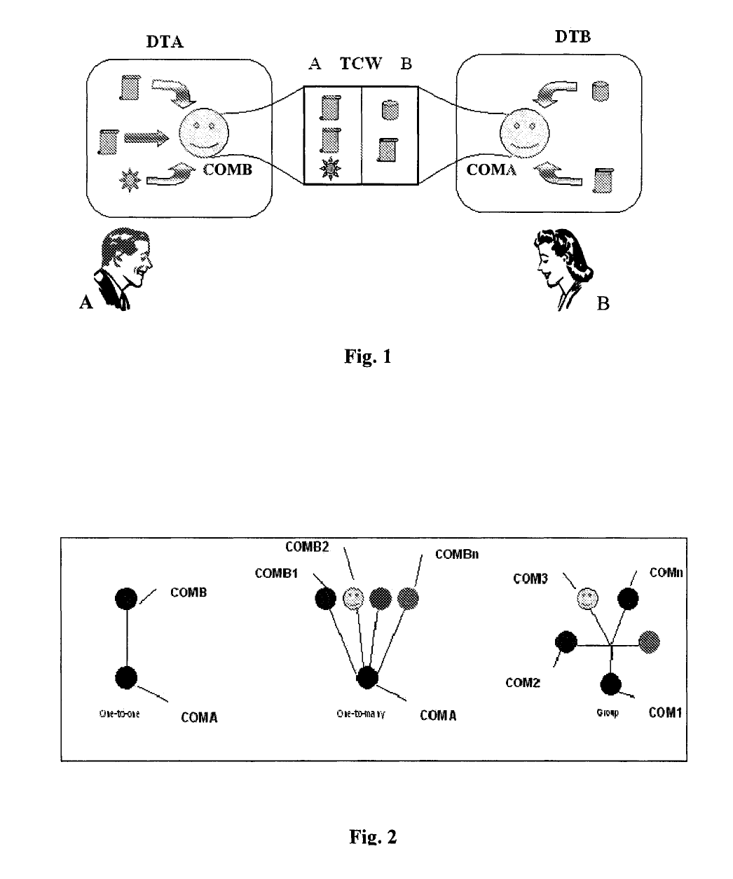

FIGS. 1 to 3 illustrate the basic properties of the system architecture of a communication system according to the invention which provides a communication environment in which contacts for communication of any type (e-mail, SMS, telephony, instant messaging, file sharing . . . ) are permanently or at least semi-permanently in contact with each other. To this end special, graphically representable contact elements, so-called Communications Robots or ComBots for short, are provided on the desktop of the computer (desktop) of the respective contact partner.

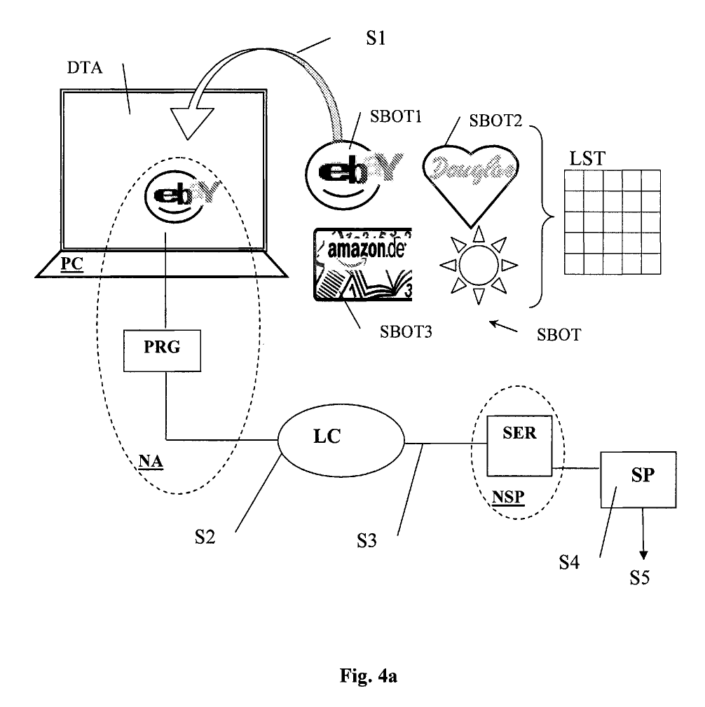

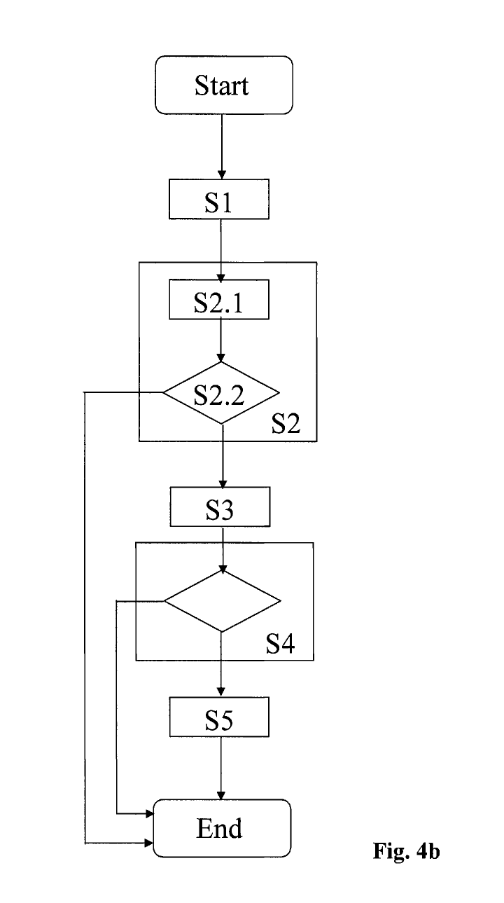

Contact partners can be users in the narrower sense, i.e. natural persons who are registered as users of the communication system. However, contact partners can also be any type of contact entities or communication entities, i.e. also technical entities, such as PCs and PC systems which are part of the communication environment. Webservers which can be reached over the internet and which are integrated in the communication environment are in particular to be named here, in order that users can establish contact with them. In connection with the provision of services the connection between the contact partners “user” and “webserver” is particularly interesting. This version of the invention is later described in more detail with the help of FIGS. 4-7. Firstly, the principle of the set-up and sequence of the method for the creation of a two-point connection between two users (natural persons) is described:

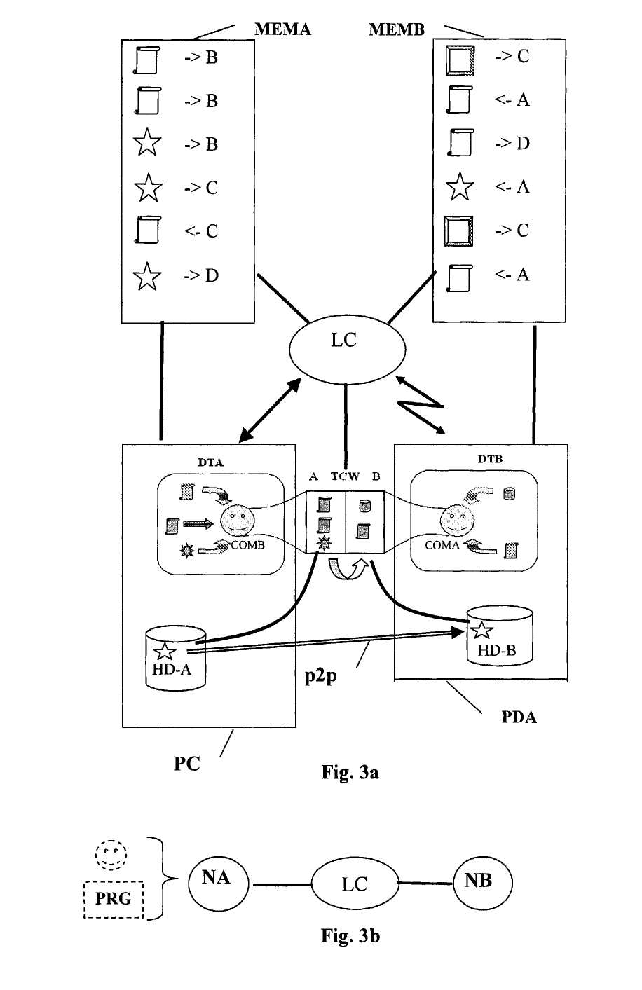

FIG. 1 shows in schematic representation an existing contact connection between the first user A and the second user B. The respective desktop DTA of user A and DTB of user B and the respective graphic element are represented in the form of a ComBot which represents the contact with the other user. Thus the ComBot for user B is found on the desktop DTA and vice versa. Both users are logged onto a system still to be described in greater detail (cf. FIG. 3a) so that the users are permanently in contact with each other and are to be seen as contact partners who possibly wish to communicate with each other spontaneously. The connection between the users is also a quasi-permanent contact connection which serves as precursor to the spontaneous set-up of one or similarly several communication connections. To this end the respective ComBot displays the current status of the contact partner by a graphic modification, animation or by comparable measures. For example the ComBot B on the desktop DTA of the user A changes its appearance, such as e.g. its colour, as soon as user B is online.

The ComBots are not only to be seen as graphic elements and status indicators, but also as functional elements for direct access to the contact partner, in order to send him messages and/or files of any type. A ComBot is thus a contact element and corresponds to a program object which a user program accesses in order to establish direct access via the communication system from one contact to the other contact. The user program can also use or emulate different applications, such as e.g. an e-mail client or an application for a peer-to-peer file transfer. Thus for example user A can send a document, say, a text file, picture file or whole directories to the desktop of user B or at least grant him access rights to these files by simply dragging & dropping. To do so, user A simply drags the symbol for the file onto the ComBot B on the desktop DTA. The files and directories exchanged and/or commonly used among the users appear on a communal website TCW managed by the system, preferably within a specific window layout, such as e.g. a double window. The double window represented in FIG. 1 has essentially two part areas, one of which is allocated to each of the two users. Thus all the associated files and directories appear in the part area of the user A and likewise the associated files and directories appear in the part area of the user B. Moreover many further data and information are also provided and managed on the website TCW, in particular the actual contact data (names, addresses, e-mail addresses, telephone numbers etc.) themselves and communication data (date, time, history, type of communication, name of the exchanged files etc.). Thus the website TCW serves in particular to manage and carry out communication between remote contacts, i.e. telecommunication in the broadest sense. The website TCW is therefore also called telecommunications website. The two users can access this direct and without a login procedure via the user program, i.e. by clicking the mouse on the ComBot, or optionally also via a web browser, wherein the user needs to know the URL and be logged on. Access is preferably via the ComBots.

The shown ComBots are operated and the website TCW used particularly easily by mouse clicks and drag & drop operations on the respective user desktop, i.e. on the personal desktop and/or in the double window presented by the browser. If, for example, user A wishes to send user B a directory with MP3 audio files, then A only needs to drag the icon of the directory on his desktop DTA onto the ComBot B of the other user and drop it there. Thus the system will automatically provide this directory on the website TCW for user B and report this to user B by animating the ComBot A on the desktop DTB. A transmission of directories and/or files takes place in the same manner, i.e. by simple drag & drop, in the opposite direction. This is illustrated by the arrows in FIG. 1. It may be sufficient for the provision of files for user B to merely maintain a link with access rights, but the file in question is not on the website TCW, but in another memory location, such as e.g. on the PC of the offering user A. As soon as user B clicks on the link the file is then read by the PC of user A, optionally copied and possibly even compressed and/or stored, converted into another format, at a memory location specified by user B which can be e.g. the TCW or also his terminal PDA.

Within the window arrangement (window layout) it is shown on the website TCW what files and directories have been provided by what user for use by the other user. The physical memory locations can lie centrally on a server of the system or can also lie decentrally on the respective computers and terminals of the users or on other external PCs, e.g. as webspace with access safeguarded via the LC system. By clicking on the respective ComBot or by accessing the website TCW which can be reached at a specific URL the users can inform themselves of the current status and, if desired, import individual or multiple files as well as whole directories into their area. This means for example that by dragging and dropping onto the webpage of the website TCW user B shifts a file located there in the part area of user A into his part area B. Alternatively or also additionally, this file can be automatically downloaded or copied from the TCW onto the computer of user B. The procedures are described later in more detail with the help of FIGS. 2a and 2b.

FIG. 1 illustrates a quasi-permanent contact connection being produced between two users A and B (contact partners), a dedicated website TCW already being provided for this purpose and the current status being displayed on the respective desktops DTA and DTB of the computers and/or the displays of the users' terminals, wherein the respective contact partner is directly accessed by means of contact elements, the so-called ComBots. Thus a direct two-point connection is set up between two contact partners via their ComBots COMA and COMB.

However, as is shown by FIG. 2, multipoint connections of any type are also conceivable, such as, say, a fan-like point-to-multipoint connection starting from a ComBot COMA to several ComBots COMB1, COMB2 . . . COMn, or stellate multipoint connections between a large number of ComBots COM1, COM2, COM3 . . . COMn are created. In the cases of the multipoint connections, a ComBot (e.g. COMA or COM1-COMn) can in each case represent a large number of contacts, i.e. a group of contacts. In this connection one can also speak of “GroupComBots”. The multipoint contact connections can be seen as a combination of several direct two-point contact connections.

The individual contacts and also contact groups are displayed within the communication application in the same graphic way, namely by the above-described ComBots or GroupComBots. Thus for every contact a ComBot in the form of a symbol (icon) is displayed on the desktop of the user's PC. For a contact group a GroupComBot, i.e. a corresponding group icon, is displayed on the desktop, which comprises several ComBots and which disintegrates e.g. when double-clicked, into the corresponding individual ComBots. GroupComBots are formed e.g. very simply by dragging and dropping the icons: thus if one ComBot is dragged onto another ComBot and dropped there, a GroupComBot automatically forms which comprises the two individual ComBots. The presentation of contacts in the form of such ComBots has i.a. the advantage that the user immediately has access to contacts and the grouping is very clearly represented. As the user himself is also a contact, namely a contact for the other side, every individual ComBot has as it were as counterpart a corresponding ComBot on the desktop of the other contact. The ComBots are in contact with a contact-management system so that in each case the other contact is informed about the current status of the contact partner. Changes in status on one side are automatically displayed by graphic modification, in particular by an animation, of the ComBot on the other side. Thus there is a quasi-permanent contact connection in each case between two respective contacts which serves to ensure that the contacts are kept up to date and can communicate spontaneously with each other. The ComBots and the GroupComBots formed from them greatly facilitate the establishing of contact and readiness to communicate between users.

The method and the system for setting up such direct two-point contact connections are now explained in more detail with the help of FIGS. 3a and 3b:

The communication system LC shown in FIG. 3a is structured in an internet-supported way and essentially comprises one or more servers which manage contact data from a large number of users for possible communication and the provision of management data. The system LC and by way of example for many users a connection between the two users A and B are schematically represented in FIG. 3a. Referring to FIG. 1, the website TCW provided for the users by the system is also represented here in FIG. 3a. The system LC provides every user with a memory area (e.g. MEM-A for user A). This memory area is located e.g. on the drive of a system server (LC server) or on a data-storage medium connected thereto. In addition to the system-inherent memory areas MEM-A and MEM-B, the users can also use system-external memories, in particular the hard-disk drives HD-A or HD-B of their PC computers or their PDA terminals in order to provide any files and/or directories for other users (contacts).

If the two users A and B are now in contact with each other via the system LC, a graphic element is located on the desktops of each of their terminals such as e.g. the PC computer or the mobile Personal Digital Assistant PDA, in the form of a ComBot which makes possible direct access to the respective contact partner. User A thus has ComBot COMB on his desktop DTA. Precisely the opposite is the case for user B. The system LC provides a website TCW for both users A and B with a double window in which all the data recorded by the system LC, in particular the contact data of the two users A and B and the management data provided by them, can be displayed. Via this website TCW and by simple operation, in particular by a drag & drop operation, the users can access their own data and the data released by the contact partner from any internet access at any time. As soon as a user changes his contact data (such as e.g. his postal address, telephone number or e-mail address), this is entered by the system LC and an automatic synchronization with the contact partners is carried out so that all the contact partners always have the latest current status of the contact data. Changes and updates can be displayed immediately via the ComBots. The system LC itself has a uniform system time, e.g. the GMT (called General or also Greenwich Mean Time) which is valid for all the nodes of the network. This is particularly important with regard to temporal documentation (histories function). Through the regular, automatic synchronization to this GMT, all nodes remain set to this system time. Thus users can be sent uniform messages, e.g. regarding specific official deadlines and occasions, such as e.g. the Olympics or other sporting, cultural or social events etc.

However, the ComBots also serve for direct and spontaneous establishing of contact, whereby a user, such as here user A, clicks on the ComBot COMB of the desired contact (here B) and then starts an application from a communication menu which appears, such as e.g. e-mail, telephony (PSTN and/or VoIP) or SMS. The user program starts the desired application with the contact data stored in the ComBot, such as e.g. e-mail addresses of the two users. Communication is immediately established with the contact partner. The system LC supports the user by proposing the possible and/or preferred communication methods, such as e.g. e-mail, SMS, IM or VoIP. The user profiles and presets of the users themselves managed by the system are taken into account. Likewise, a spontaneous communication can be prompted by simple dragging & dropping. If user A drags for example a WORD file onto ComBot COMB of his contact partner B, the system LC converts this file into a PDF format and transfers the PDF file to user B as an attachment together with a notification e-mail.

In another example, which is illustrated in FIG. 3a, the user A drags onto the ComBot COMB an MP3 file (symbolized by a star) which is currently located on the hard disk HD-A of user A's PC computer. The system LC immediately starts an upload by transferring this MP3 file into user A's system-inherent memory area MEM-A and displaying this on the website TCW. User B is now advised that A is providing him with a file. The system LC animates ComBot COMA on the desktop DTB of user B, wherein ComBot COMB receives e.g. a speech bubble with the message “MP3 from A for you”.

User B can then immediately access the website TCW via the user program or optionally surf the TCW using his browser and there access his own memory area (right-hand side of the double window) and also the memory area released by A (left-hand side). Either user B leaves the MP3 file (see star) there in A's memory area or user B has the file transferred into his memory area. He can carry this out by dragging & dropping the file symbol, i.e. here by dragging the star from left to right (see arrow). The system LC immediately controls a corresponding file transfer from hard disk HD-A onto a memory area given by user B, here onto hard disk HD-B which is located in user B's terminal, here in his mobile Personal Digital Assistant PDA. The file is transferred via a two-point connection in the form of a peer-to-peer p2p transfer. Many other applications are conceivable, such as e.g. also a direct communication which integrates asynchronous communication (e-mail) with synchronous communication (instant messaging), wherein the most varied communication formats and data (texts, audio, video etc.) can be transmitted. The communication system LC is particularly characterized in that it makes all possible communication technologies for contacts usable spontaneously by simple desktop-optimized operability, wherein the contact data are automatically updated.

The system LC causes the contact partners to be connected to each other by ComBots via any communication networks, in particular over the internet. The contacts' ComBots are thus to be seen as network nodes, as illustrated in FIG. 3b. The logical structure of a two-point connection is represented there which connects network node NA, which is allocated to the first user (cf. A in FIG. 1), to network node NB, which is allocated to the second user (B). Each network node comprises both the graphic element of the corresponding ComBot and also the functional elements (contact data etc.) which serve as program object for the user program. The structure of the contact elements here called ComBot and their function as so-called ServiceBots is described in more detail below:

FIG. 4a shows within the framework of a functional block diagram the structure and also the sequence of the method according to the invention in which a user (here user A from FIG. 1) accesses special contact elements which are provided by service providers themselves or to their order for the users, in order to make possible for them a direct contact with the providers and the use of services or at least to use communication functions supplied by providers. These contact elements are thus special ComBots which comprise services and/or functions provided by suppliers and are hereinafter called “ServiceBots” for short. Represented here by way of example are three ServiceBots SBOT1 SBOT2 and SBOT3 and one more which are part of a selection list LST. The different ServiceBots are prefabricated program objects which are provided to the user for example by e-mail or on websites. If the user drags the ServiceBots desired by him onto his desktop DTA using drag & drop, the user program starts automatically with the setting-up of an LC connection to the corresponding service provider. This can be e.g. an online shop, such as the well-known online book mail-order firm Amazon, or a specific goods supplier, such as the well-known chemists Douglas. Corresponding ServiceBots are represented in FIG. 4a and given the references SBOT2 or SBOT3. Each ServiceBot represents a unique contact element and is equipped comparably to a ComBot with graphic and functional elements. The graphic element comprises essentially an optical presentation and illustration of the service provider. The functional elements comprise i.a. contact data relating to the provider and various parameters which give the user quick access to the services which the service provider holds ready, and/or which make possible access to communication possibilities which are provided exclusively by the service provider. The term “service provider” is to be understood very generally and covers any type of entity which offers the user services, communication facilities or other facilities through ServiceBots. Accordingly, sponsors or other entities and organizations can also provide ServiceBots in order e.g. to advertise events or products, in particular in order to offer vouchers, bonuses or discounts and the like. Thus e.g. discounted access services for downloading music and video files can be sponsored. Many further applications are conceivable. The graphic layout of the ServiceBots can itself be a special feature which is offered only to specific users who enjoy a privileged status (“gold status”). Or users can download onto their desktops against payment specific ServiceBots or ComBots which have special design and/or functions. Thus ServiceBots or ComBots prefabricated to an exclusive design (limited edition) can also be supplied. The user can then use the design for his existing ComBots. In the example according to FIG. 1 user A could acquire a ComBot with a Disney design and use this design for the ComBot COMA, which represents contact partner B. The functional elements of the COMA can remain unchanged or else be expanded to include additional functions (e.g. for the no-charge dispatch, of a number predetermined by the sponsor, of SMS or the use of PC games etc.).

The method according to the invention is represented in the form of a flowchart in FIG. 4b which relates directly to FIG. 4a. Therefore reference is made hereinafter to both FIGS. 4a and 4b: in the example shown here the user selects the ServiceBot SBOT1 of the online auction service provider Ebay. User A is to serve as an example here (cf. also FIG. 1): he is called “Axel Ast” and registered in the LC system with his e-mail-address axel.ast@web.de. In a first step S1 the user drags the SBOT1 by drag & drop onto his desktop DTA and installs it on his PC. In a next step S2 the user program PRG accesses the program object, which is defined by the functional elements of the SBOT1, so that a logical network node NA results which is connected to the system LC (part-step 2.1). The user program reports, acting as a client with the data of the node NA, to the server of the LC system, wherein the data come in particular from the contact data contained in SBOT1. As user A is already registered in the system LC, he is immediately authenticated by the system. Moreover it is checked and recognized with reference to the contact data (part-step 2.1) that a connection is to be set up to the service which the SBOT1 represents. In this case a connection to the auction service Ebay is thus produced. This happens in a further step S3 in which the LC server establishes contact with a network node NSP which is allocated to the service provider SP (here: Ebay). The node NSP comprises in particular a webserver or a web service of the service provider SP which provides the offered facilities or at least administratively supports and monitors their use. The node NSP is thus a contact entity which is allocated to the service provider and which the user can use. An entitlement check with the service provider can be dispensed with if user A has already been authenticated by the LC system. Access to the service is thus quicker and more immediate. The user no longer has to log in with his service provider. This becomes very simple in particular if the user registers in the LC system with the same characteristic data as also with the service, e.g. with the same user ID or e-mail-address (here: axel.ast@web.de) or similar characteristic data. This is tested in a step S4. If the result is positive the user then immediately gains access to the user-specific facilities of the service provider. Then the corresponding functions are activated and/or cleared for the user in a step S5. Via the ServiceBot the user has direct access to his service provider and the user area set up for him there. The user does not need to install e.g. any so-called toolbars of service providers.

In the “Ebay” example described here user A could obtain immediate access to his Ebay account (“My Ebay”) and use all the facilities there. The user thus needs only to click on the ServiceBot SBOT1 and is automatically connected to Ebay and his account there. He can then immediately participate in auctions, monitor his account etc. The user can thus control all user-specific events by ServiceBot. Likewise the incoming events can be immediately displayed to the user by ServiceBot. This happens e.g. by animating the graphic element (here: icon SBOT1).

The described method has many advantages: no invitation procedure with confirmation is required in order to be able to use a service. An authorization request via login and password at the service provider can be dispensed with, as authentication is assured via the LC system. In other words: as the LC system knows its users, the provider can trust the accuracy of the LC user identity, so that the actual login procedures at the supplier can be dispensed with. A new convenience function results which can be called “One Click To Service”.

The ServiceBots presented here are prefabricated ComBots with which contact connections controlled by the LC system between users of the LC system and various providers, in particular service providers, are automatically set up. For this, an interface in the form of a webserver or web service is provided between system and provider. The provider (e.g. Ebay) then supplies all his customers who are also LC users via this interface. The service and its provider are represented by a corresponding ServiceBot on the desktop of the user's PC. Any conceivable service functions can be offered to the respective user, in particular access to personal areas (My Ebay), via the ServiceBots. And the provider reaches his customers directly via the interface to the LC system. For this, ComBots and/or GroupComBots can also be applied on the provider side, say on the desktops in the customer care centre. However, on the provider side at least a non-visible LC contact access is applied for each customer. This means that on the side of the provider SP from a logical and purely functional view many virtual contact elements (ComBots) exist, namely one element each for every contact (user, customer). But in terms of system engineering these are contact accounts (user or customer accounts) which the provider runs and which he uses to operate the ServiceBots in order to provide his customers with particular services and/or functions.

If a user wishes to use a specific service, he uses drag & drop to drag the desired ServiceBot onto his desktop. The ServiceBot contains supplier-specific data (service ID, IP address of the webserver etc.) of the corresponding service provider (e.g. IP address at the Ebay server). The user program, e.g. in the form of an LC client, now sets up a connection to the service provider's webserver with the provider-specific data. The service provider's webserver will automatically and immediately accept the LC connection to the user and the functions (My Ebay) supplied by the service are immediately provided for the user. The ServiceBots are thus prefabricated contact elements with intelligent properties which are tailored to the use of services corresponding to the presets of service providers or sponsors.

The principle presented here of equipping contact elements with intelligent function capabilities applies quite generally to every type of ComBot. It thus applies also to normal ComBots, but is particularly advantageous when equipped as a ServiceBot.

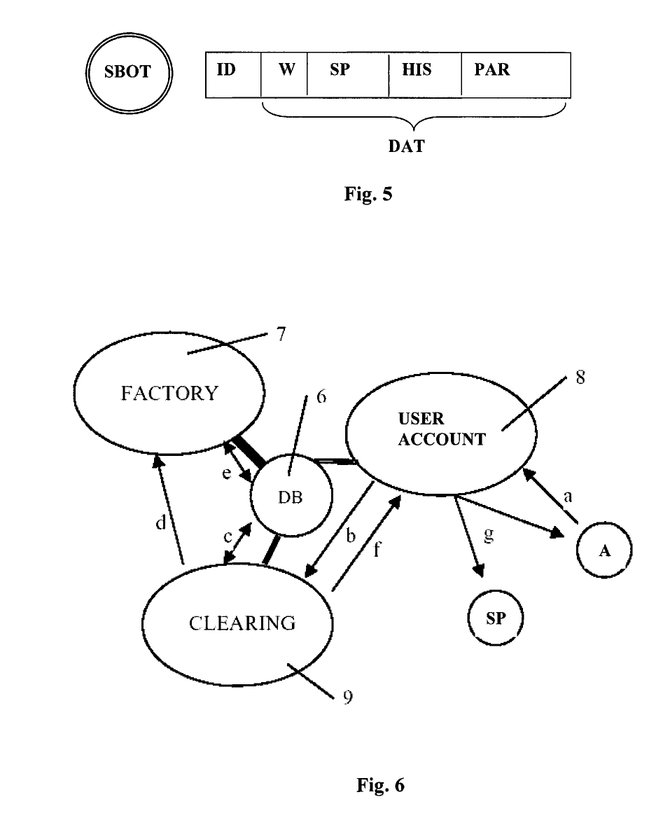

An example of such an intelligent ComBot according to the invention is represented in FIG. 5. The ComBot is in the form of a ServiceBot SBOT and is offered by a service provider in order to make specific functions and services available to the user. This ServiceBot SBOT is also not only a graphic element which represents the respective service provider on the user's desktop, but comprises functions for the direct establishing of contact and communication with the service provider or with a contact determined by him (e.g. Service Centre) as well as for the use of services, in particular online services, such as, say, purchase and mail-order services (online shopping), auctions, gaming and entertainment services (e.g. lottery) and others. The ServiceBot SBOT can also cover a digital currency unit and represent a certain amount of actual money, e.g. one or more Eurocents. Each ServiceBot represents a file of e.g. 10 kB. As represented in FIG. 5, this file comprises different DAT information relating to the ServiceBot. There are preferably specific data fields for this:

In the first field stands the actual identification ID which gives the unambiguous identity of the ServiceBots and corresponds e.g. to a 32-bit numerical code. This is an identity recognition, article number or serial number which is unique for every ServiceBot, so that every ServiceBot can be unambiguously recognized and can be identified precisely within its uses, in particular in cases of payment procedures and transactions. Thus e.g. specific batches of ServiceBots can be given say in the form of blocks of numbers. This means that e.g. 1 Million ServiceBots with the end-numbers “ . . . 0” to “1,000,000” are allocated to a service provider or sponsor. This gives additional security. The unambiguous identification ID of every single contact element, i.e. of every single ServiceBot or ComBot generally, corresponds to an article or serial number which allows specific properties and third-party rights, in particular license rights, copyright, picture rights and associated use, enjoyment and/or marketing rights to also be connected to every contact element. Proper use is thus monitored at all times. Thus picture, sound, music and license rights of a third party, such as e.g. the Disney Company, can be acquired for graphics and design of ComBots for e.g. a number of 50,000 items. Precisely 50,000 ComBots or ServiceBots can then be produced and disseminated, e.g. in the form of sales, sponsorship or also leasing. In the last case the receiver of the ComBots can use it for a predeterminable period of time and then must extend the lease again. There is a virtual subscription which can be extended if required.

If the ServiceBot is also to serve as a digital means of payment, details of the denominations of the monetary units can be given, thus say in denominations of 10, 50, 100 and 1000. In the second field e.g. the value W can be stored in a specific currency unit.

The provider himself or a sponsor SP is entered in the third field, preferably in the form of an ID number. The ServiceBot can thus be allocated to a specific sponsor or advertising partner. In the fourth field data are stored relating to the transaction history HIS, such as e.g. date of all transactions, or at least of the last N transactions. The fifth field contains further parameters PAR. These parameters PAR can comprise various information. Thus the ServiceBot SBOT can display an expiry date. The ServiceBot can also be limited to purchase at specific suppliers or dealers. Additionally the ServiceBot can lose or gain value with every use. The parameters PAR can also contain information regarding specific bonus, payback or discount campaigns. Via the parameters PAR the ServiceBot can also be used for only a limited number of transactions.

Possible transaction information which is stored in the history HIS can be e.g. date, time, place, amount, transaction partners. This information forms part of the parameters PAR. Further parameters can be an expiry date and the fall or rise in value. Also, details about a limitation to specific products and/or services can be parameters, as can a predetermined maximum number of transactions.

The definition of the parameters thus determines further properties of the contact element and is very versatile. This applies equally to ServiceBots and ComBots generally: thus the parameters can predetermine e.g. different features, in particular size, colour and graphic resolution, of the contact element depending on the display on the user terminal. The contact element is then better represented on a terminal, such as e.g. a PC with good display, than on a mobile terminal with a small display. The contact element is to be seen as a multimedia representation which also comprises acoustic properties. Therefore the parameters PAR can also indicate such properties as e.g. the acoustic representation of the contact element, in particular when events occur. Thus a ServiceBot can e.g. reproduce the signature time (jingle) of a specific product, in particular whenever a new message or information about this product reaches the user from the service provider. The parameters PAR can also be seen as a means of service identification, in particular together with the identification SP. This means that these parameters also give different properties for different services, such as e.g. period of use, extent of credit, discounts, intended use etc. The properties can also experience time-related changes, e.g. the discounts are very large at first and then decrease in graduated stages. This is e.g. also particularly of benefit for intelligent advertising measures such as e.g. “dynamic early-booker discounts”.

A further particular possibility is the use of the ID recognitions and/or SP themselves alongside the parameters PAR to logically assemble several contact elements in one predefinable quantity and provide them with quantity properties. Such quantity properties can be exclusive rights for all users of these contact elements, such as e.g. access rights to exclusive communication networks, in particular to virtual private networks or to special databases etc. In this connection in-house contact elements (Corporate ComBots) could also be produced which are provided only for employees of a company and e.g. allow access to in-house networks. For this, a management system for employee accounts is also set up which the provider, i.e. the company, can run. The management system exchanges data with the user adminstrator of the LC system and can therefore also be set up as constituent of the LC system or else be set up externally at the provider. Exclusively specific rights, in particular access and rights of enjoyment for selected groups, are thus granted via the contact element's CorporateBots.

In the same way as company employees can be equipped with CorporateBots, special customer groups or also supplier groups can also be provided with exclusive contact elements by corresponding CustomerComBots or VendorComBots. Not only the functionality of the contact elements is of importance. The graphic appearance is also of great importance at least for customers. If e.g. only a few contact elements which are particularly expensive in terms of graphics are divided among a small customer group, these contact elements can acquire a value of their own as typical collectibles. Think e.g. of ServiceBots which are produced and distributed by Porsche or to their order with exclusive logo and design.

A further special feature of the intelligent contact elements presented here is also the flexible predeterminable linking of graphic elements with functional elements. Thus e.g. a ComBot or also ServiceBot can be designed in the form of the well-known Disney figure “Mickey Mouse” (graphic elements) and have specific animation properties (functional elements). These are predetermined in the parameters PAR and could be e.g. graphically and acoustically animated forms of expression, such as e.g. crying, laughing, smiling, cursing etc. However, these animation properties, i.e. functional elements, are independent of the specific form of the contact element, i.e. independently of the graphic elements. Accordingly, the functional elements could also be transferred to another form (e.g. Donald Duck).

The production and use of the ServiceBots is represented in FIG. 6. The principle described here also applies to ComBots generally. An environment with a central database 6, with an entity 7 for producing ServiceBots (a so-called factory), with an entity 8 for handling ServiceBot services and for running the user accounts (so-called user management) and with an entity 9 to safeguard the handling of ServiceBot services (a so-called clearing post) is provided to use the ServiceBot. The factory 7 is the entity, post or unit which produces the ServiceBots and optionally destroys them. Further processes can also be carried out there which are described in more detail later. The user administrator entity 8 itself serves to handle the payments and run accounts, in particular the user accounts. Accounts of transaction partners, advertising partners, sponsors etc. can also be run there. The clearing post 9 is an entity, post or unit which checks and protects the transactions to be carried out. The precise operation of the individual elements becomes clear from the following description:

All existing ServiceBots are stored in the database 6, each in the form of its own file. The database 6 thus has a memory space for every existing ServiceBot.

According to FIG. 6 the factory 7 is the only entity is able to modify the ServiceBot files in the database. Only the factory 7 can overwrite or delete the information allocated to the ServiceBots. The user administrator entity 8 and the clearing post 9, on the other hand, can only read the data of the database 6. In another, not represented, embodiment the user administrator entity 8 and the clearing post 9 are also authorized to modify the data in the database 6. The user administrator entity 8 is thus the interface with the owners of the ServiceBots, (e.g. with user A, cf. FIG. 1). Here an owner can see how many ServiceBots he has and commission transactions. The user administrator entity 8 can, however, also manage information relating to the service providers, such as e.g. the characteristic data SP (cf. FIG. 5) and account data. The clearing post 9 serves to monitor, check and handle the ServiceBots' transactions.

A transaction according to the invention i.e. a payment procedure carried out by means of a ServiceBot, is now described with the help of FIG. 6:

User A has an online account with the user administrator entity 8, which also comprises a bank, with which his ServciceBots are run. As already described, the ServiceBots can be used for the most varied applications, thus also for payment procedures in online shops. In the example represented here in FIG. 6 the user wishes, using such a ServiceBot which is also formed as digital monetary unit and corresponds to a monetary value W (cf. also FIG. 5), to buy over the internet e.g. an audio CD from an online shop which the provider (merchant) SP operates. User A instructs the bank to transfer the required amount to an account of the trader SP (step a). The value W is stated e.g. in the form of so-called WebCents, which correspond to precisely one Eurocent. In the shown example, the ServiceBot has been produced as a credit with the value W of 2000 WebCents, which corresponds to precisely 20 Euro. The product offered by the merchant SP, here the said audio CD, costs e.g. 15 Euro. To pay for the audio CD, the user A instructs the bank (via the user administrator entity 8) and the clearing post 9, to transfer an appropriate number of WebCents, namely 1500, from the account of A to the account of the merchant SP. The bank sends the clearing post 9 the ID number of the ServiceBots and the number, i.e. the accounting value, of the WebCents to be transferred and the name of the previous owner (user A) and the name of the future owner (dealer SP).

The clearing post 9 now asks the database 6 to check whether the quoted ID number also actually corresponds to a ServiceBot which comes from the provider SP and whether the value W is greater than or equal to the quoted number of corresponding WebCents. For data security, the ID number can e.g. be issued according to a specific pattern or scheme (pseudo-random) and only the clearing post 9 can also check at this point whether the quoted ID numbers fit into the use scheme. The clearing post 9 also checks whether the ServiceBot formed as credit also actually belongs to user A. For this e.g. the history HIS stored in the data field 4 is read out (cf. FIG. 5). With the help of the parameters PAR the clearing post 9 can carry out yet further checks.

Thus e.g. the expiry date of the credit (ServiceBot) can be checked if it has one. If the ServiceBot is provided for the purchase of only specific products the clearing post can acquire additional information through the bank about nature of the purchase, and compare this information with the corresponding parameter PAR.

When addressing a query to the database 6 the clearing post 9 preferably accesses the transaction history (data field HIS) of the ServiceBot in question. The history is checked for plausibility, i.e. it is checked whether the history indicates that A is the lawful owner of the WebCent in question.

If the result of the check by the clearing post 9 is negative, the transfer of WebCents is stopped. If the result of the check is positive, the clearing post 9 instructs the factory 7 to transfer the corresponding WebCents from A to SP (step d). In step e the factory 7 then transfers the corresponding data into the database 6. Alternatively the transfer takes place by means of the user administrator entity 8. The clearing post 9 now informs the bank 8 that the transaction has been successfully concluded (step f). Finally this information is relayed by the bank to A and SP (step g). If the clearing post 9 or the bank 8 are authorized to modify the data of the database 6, the clearing post 9 or the bank 8 can also carry out the corresponding transfer of the data in the database 6, instead of the factory 7. In this case the factory 7 is not involved in the transfer of the WebCents.

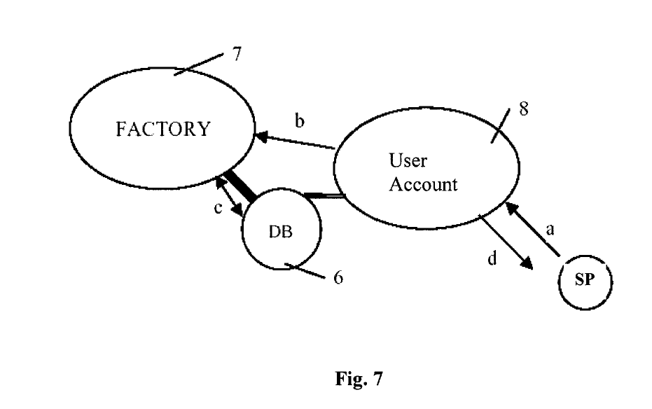

FIG. 7 illustrates how ServiceBots can be created and destroyed. The principle described also applies to ComBots generally:

The ServiceBots are created in particular by suppliers and sponsors SP or produced to their order, in order to offer the users particular services and functions. The operator of the system LC acts almost as a mediator between suppliers and users. For this, not only must the user data be managed by the system but also data about the provider and sponsors SP, such as e.g. their names, addresses, account details, contractual conditions with the mediator etc. This administration can also take place centrally in the user administrator entity 8. If a supplier or sponsor SP wishes to have new ServiceBots produced, the factory 7 receives the order. This happens via the user administrator entity 8 (step a) which instructs the factory 7 to create ServiceBots with the properties predetermined by the sponsor SP (step b). The factory 7 accesses the database 6 and generates in this corresponding new ServiceBots, i.e. a unique data record for each ServiceBot (step c). Each new ServiceBot has a unique identification (ID in field 1, cf. FIG. 5) which can have the form of an encrypted serial number or the like. The sponsor is also named (SP in field 3). The ServiceBot can also be provided with a value (W in field 2), a history (HIS in field 4) and optionally with several parameters (PAR in field 5). In the last step d the management 8 informs the sponsor SP that the new ServiceBots have been produced and delivers them. This happens by transferring the created files to the sponsor SP in question.

Because the ServiceBots are each provided according to the invention with an unambiguous identification (ID in field 1, cf. FIG. 5) and with additional information, in particular the owner (field 3) and the history (field 4) and further parameters (field 5), falsification or misuse is made much more difficult. Because additional information has been provided, the ServiceBots can be used for particular marketing purposes, in particular for advertising, sponsorship, discount campaigns or the like. The ServiceBots can be selectively produced for promotions run by a specific sponsor or for specific campaign periods (summer coupon) etc. With the help of the additional information, in particular the transaction history, various statistical information about the ServiceBots and their use can also be collected. The ServiceBots are thus special versions of the intelligent ComBots presented here. Both the ServiceBots in particular and the ComBots in general have the described data structure with the data, information and details embedded therein, in particular with an unambiguous identity recognition.

The process of providing and allocating the above-described intelligent ComBots, in particular ServiceBots, is schematically represented in FIG. 8:

The process starts from an offering entity COE which in particular also offers services for communication and which is also called “communications offering entity” below. This entity COE corresponds in the case of offered services to the respective service provider SP (cf. FIGS. 4-7). The offering entity COE can also correspond to any user (e.g. user B in FIGS. 1-3) or the operator of the LC system (cf. FIG. 3a) who wishes to offer other users communication functions. The offering entity COE wishes to make an offer to a target entity TE, also called “target entity” below, which enables the target entity TE to communicate according to the parameters defined by the offering entity COE. The target entity TE generally corresponds to a user (e.g. user A, cf. FIGS. 4-7) who is then intended to avail himself of the offer. To this end, the offering entity COE allocates to the target entity TE a communication means COM which corresponds to the described contact element, namely the intelligent ComBots, in particular ServiceBot. This allocation is represented in FIG. 8 by the arrow 1. From a technical point of view the COM can be allocated to the target entity TE by sending at least a part of the COM via the network N. The network N is preferably part of the communication system (see system LC in FIG. 3a), but can also be independent of it. The transfer of the contact element COM ensures that the target entity TE receives and can install the data and/or program parts linked to this element and is then prepared for the direct establishment of contact and communication. The actual contact connection then takes place, as described, via the networks of the communication environment. The network N contains at least one network for communication between COE and target entity TE. Examples of the network N include computer networks, in particular the internet, fixed and/or mobile telephone networks and similar. With the provision of the contact element COM the target entity TE, in particular the corresponding user, can communicate according to the communication parameters, as represented by the arrow 3 in FIG. 8.

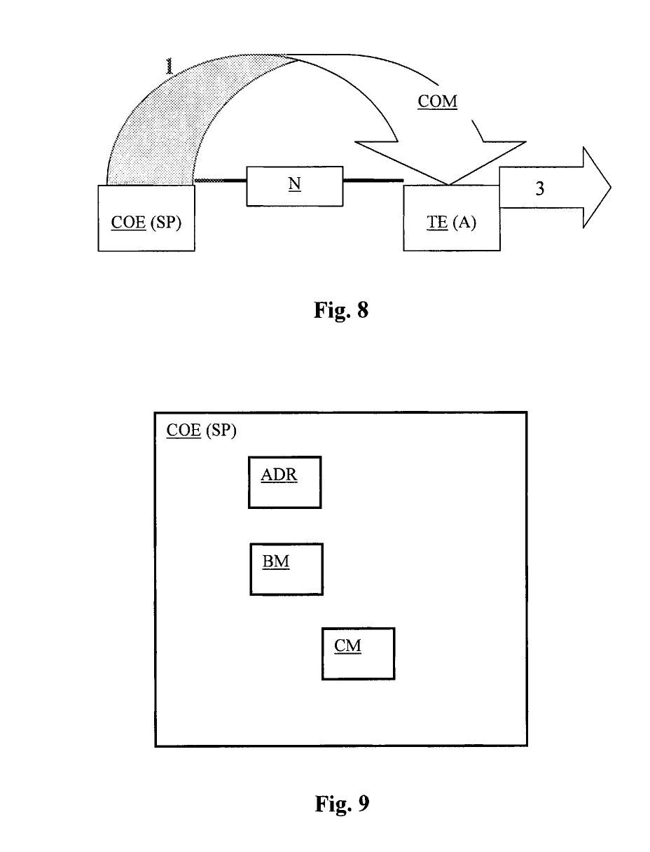

As represented in FIG. 9, the supplying entity COE contains addressing means ADR, building means BM and control means CM. The addressing means ADR contain information on the basis of which the entities can be identified. Such information includes names, addresses, e-mail addresses, telephone numbers, fax numbers, numbers of SMS sets and the like. The addressing means ADR can be used by the offering entity COE for various purposes, in particular for the applications described here in relation to the definition of communication and contact elements COM for the target entity TE. To define and create these COM elements the offering entity COE first selects, using the addressing means ADR, information which indicates an entity COE selected as target entity TE. The COE then uses the building means BM to create the COM elements. The elements COM comprise at least an embedding of information which identify the TE such that the created elements COM are unambiguously allocated to this target entity TE. Where the COE aims to use standardized and/or prepared COM contact elements, the building means BM provide models or templates for the COM which contain standardized communication parameters as predefined parameters. By implementing information which identifies the target entity TE (user), personalized contact elements COM are produced at the user. In order to implement the contact and communication parameters therein as the supplying entity COE wishes, the building means BM provides functions for defining and embedding the parameters.

After their production the contact elements COM are allocated to the target entity TE (user). It must be mentioned that the elements COM can also still be monitored by the offering entity COE after their allocation to the target entity TE. In relation to the communication parameters the building means BM make it possible to amend and vary the parameters and/or implement additional or new parameters and/or to delete again previously embedded parameters, even if the communication parameter COM has already been allocated to the target entity TE.

The elements can be controlled by the control means CM. Compared with the building means BM the control means CM allow present operating conditions and/or the behaviour of the elements COM to be monitored. The control and monitoring by the control means CM have no influence on the communication parameters implemented.

In order to promote a proper understanding of the differences between the building means BM and the control means CM, reference is made to the following example: An offering entity (cf. COE, communications offering entity) designs models, such as e.g. model aeroplanes or model cars (cf. COM, communications offering means) and has a workshop (cf. BM, building means) in which a desired model is constructed for the user (personalized communications offering means) and can be amended later if necessary. To define and modify, if necessary, the properties of the model the offering entity (COE) can select from a large number of components of the workshop. After having decided on specific properties (cf. contact and communication parameters) such as e.g. the property “flying” for the model aeroplane the entity can still make modifications. During operation the user (target entity) can control the model remotely (control means). However, the remote control is limited by the properties (parameters) of the model (COM). For example, remote control of the flying model allows a large number of maneuvers to be carried out which are limited by the properties of the model. However, the remote control cannot cause the flying model to be operated as a model boat.

A service provider or sponsor particularly comes into question as offering entity COE (cf. SP in FIGS. 4-7) in which case the intelligent ServiceBots are produced as elements COM. The target entities TE are the users of the system LC who are already customers or at least potential customers of the offering entity, thus of the provider or sponsor SP. However, an individual, namely a user of the system LC who would like to offer an intelligent ComBot to another user, also comes into consideration as an offering entity COE. The embodiment example shown in FIG. 9 for an offering entity COE includes the addressing means ADR and even also the building means BM and control means CM. However, it may be enough if at least one of the means ADR, BM and/or CM forms part of the supplying entity COE.

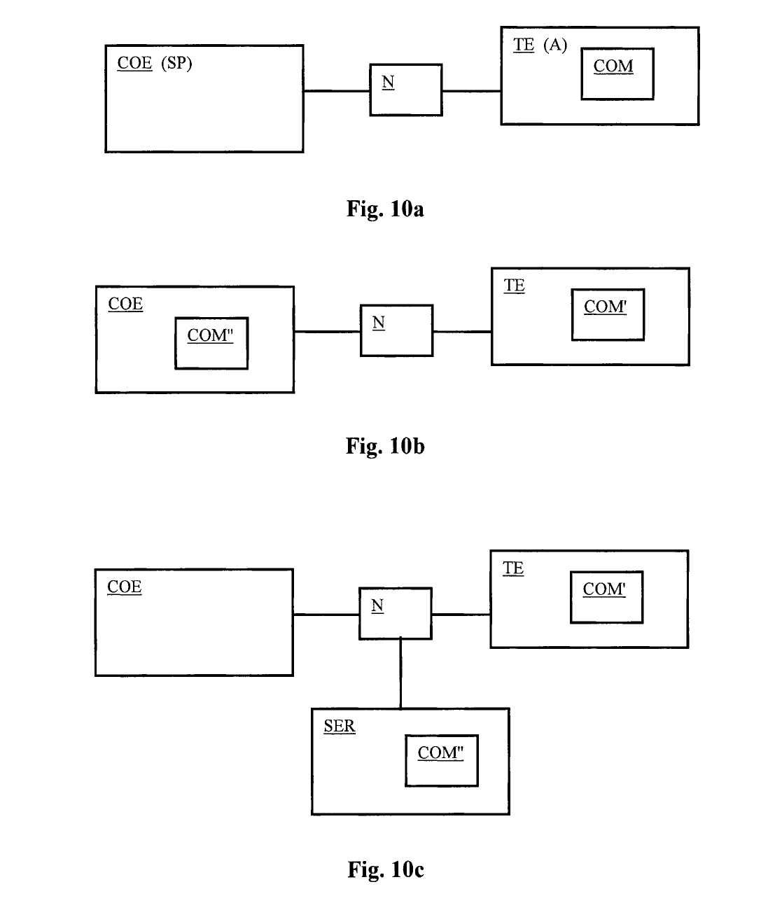

FIG. 10a shows that the allocation of a contact and communication element COM to a target entity TE can be designed such that the element COM is transferred as a whole to the target entity TE. As a result the target entity TE then contains the whole of the element COM. FIGS. 10b and 10c illustrate embodiments in which the whole of the COM element is not completely contained in the target entity TE. In these examples the target entity TE contains a part COM′ of the COM element. The COM element is formed by combining the part COM′ with a second part COM″ which is contained in the offering entity COE or a central computer system SER. In the shown examples the offering entity COE is a service provider (sponsor) and the computer system is a webserver SER of this service provider. At least a part of the contact element (ServiceBot) is held ready on this webserver. Thus it is possible that a part COM″ of the COM contact element lies on a server SER which forms e.g. the part of a database. Accordingly the COM elements in the form of combinations COM′ and COM″ can use the resources on the server and thus also be equipped with data which are not, or are supposed to be, available at the target entity TE. These include i.a. also statistical data which concern the behaviour of the user when using the COM, such as e.g. calling and access times, frequency, addresses, in particular URL and/or IP addresses, of visited servers, websites or webpages etc. It is also possible to define only the graphic properties of a ComBot in the first part COM′ and the functional properties in the second part COM″. Thus the user has only the data for the graphic version or the design of the ComBot, thus the COM′, stored locally on his terminal and can modify the design if necessary. The data for the operability of the ComBot, in particular authorizations, profile data for services and animation data for the animation of the ComBot however lie as COM″ on the offering party's server (cf. FIG. 10c). The offering party thus has central control over the essential functionalities of the ComBots or ServiceBots provided by him. The management of the data COM″ becomes even more secure and data maintenance, in particular updates of authorizations and functions, becomes clearly simpler. Conversely, it is also conceivable that the function data COM″ are stored and installed on the user terminals and the graphic data COM′ are stored and centrally managed on the offering party's server. This is then advantageous e.g. if the offering party wishes to offer and supply mainly specially designed ComBots which have the same basic functions but are differently designed in terms of graphics. Thus the file COM″ could be stored on the user's terminal which defines basic functions for the animation of ComBots, such as e.g. laughing, crying, running, sitting, standing etc. The COM′ files on the offering party's side define the form of the ComBot, thus e.g. a representation as “Mickey Mouse” or another as “Donald Duck”. By combining both files an animatable ComBot is created in the respective form (e.g. “Mickey Mouse”). If the offering party wishes to supply specific users with a special ComBot, e.g. in the form of “Bad Man” then he only needs to issue a correspondingly new COM″ file to the user. The new ComBot would then have the new form of the “Bad Man” but the same basic functions as “Mickey Mouse” or “Donald Duck”. It is not necessary to produce and supply a completely re-defined ComBot.

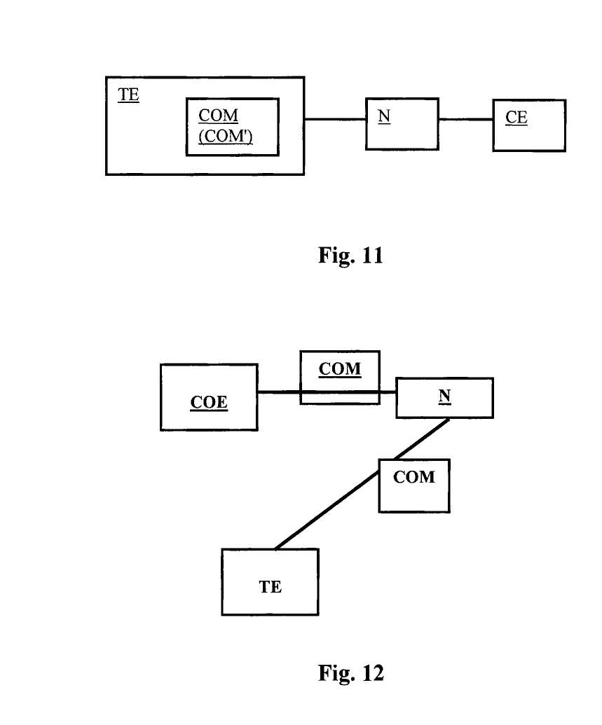

FIG. 11 illustrates the case in which the target entity TE has an individual independent terminal (stand-alone), such as e.g. a personal computer, a mobile telephone or a fixed-network telephone etc. The contact and communication offer is conducted to this via the COM element. The offer is displayed by a graphic element (icon) on the desktop of the terminal of the target entity TE, namely in the form of the described ComBot and/or ServiceBots. A connection to a called entity CE is produced via the network N by actuating such an element, i.e. by clicking on the mouse on same or by drag & drop operations. This entity CE corresponds to the called user (contact partner B) described already with reference to FIG. 1 or the webserver described with reference to FIG. 4a of the service provider. The types of data embedded in the intelligent contact elements COM (ComBots or ServiceBots) are e.g. audio data (speech, sounds, music) and/or video and picture data and can be used to create corresponding acoustic or visual information, such as e.g. in the following cases:
when providing intelligent contact elements COM for the target entity TE, in order to advise the target entity TE that the elements COM are now allocated;
while using the elements, in order to inform the target entity TE that the elements COM are ready for use or actively connected;
in order to provide a contact and communication offer and draw attention to it;
to show that a element COM is currently being monitored and/or controlled;
to show that the contact and communication parameters are being modified or have been modified;

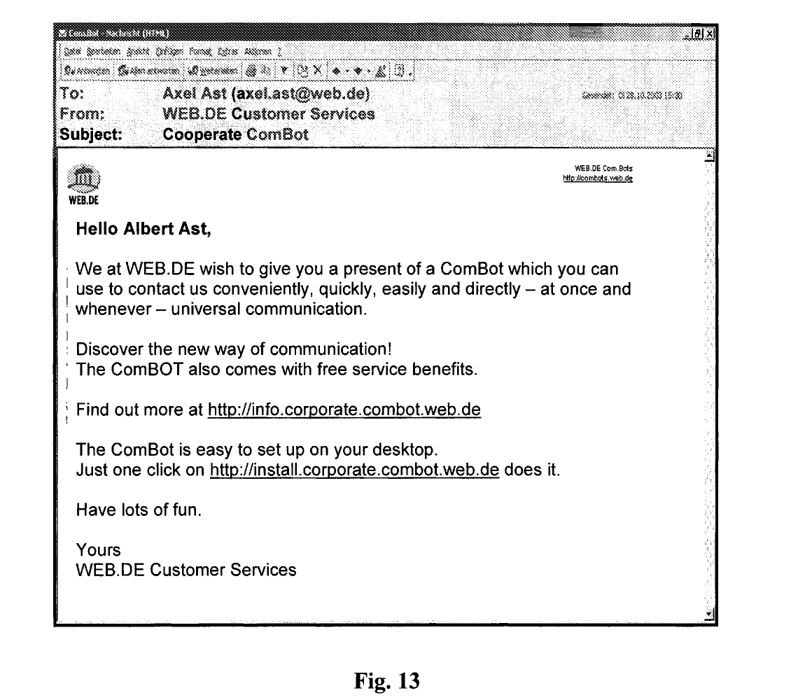

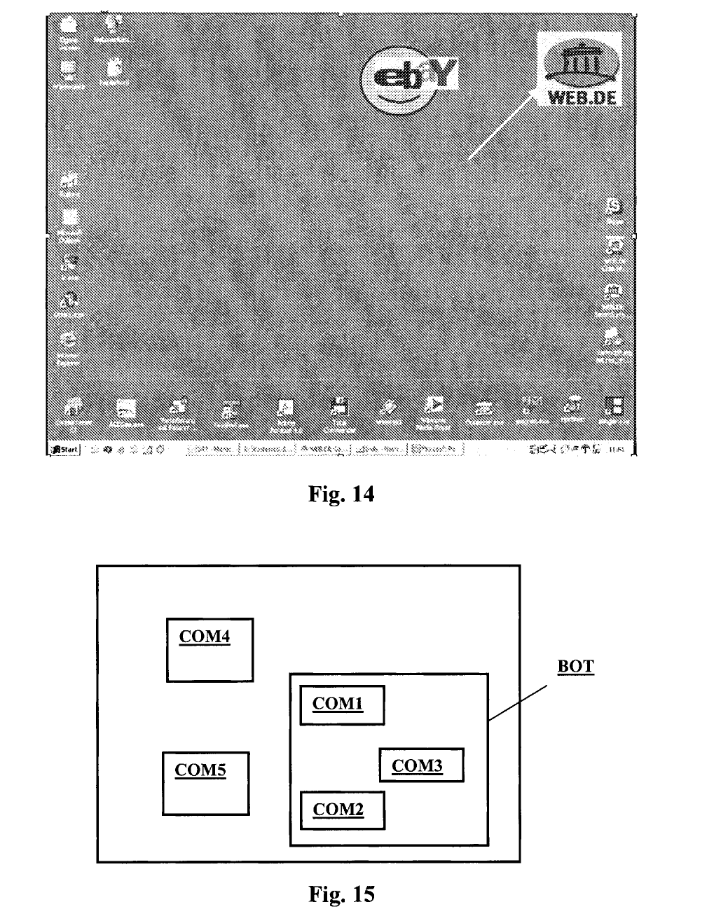

If an element COM has been produced, the COE provides at least part of the COM, at least part of the COM being transferred via the network N to the target entity TE (cf. FIG. 12). An e-mail can be used for this purpose which contains data, information and/or software in order to form the COM (cf. FIG. 13). This e-mail is directed towards the target entity, i.e. towards a user or a potential user, and it serves as an invitation to establish contact with the sender, who can be e.g. a service provider. The e-mail contains the contact element COM (ComBot, ServiceBot) or at least a link to a webserver on which the element COM is stored. If the element COM has been received and installed at the target entity TE (user), an icon or picture selected for the COM is represented on the display of the target entity TE (cf. FIG. 14).

FIG. 15 illustrates a version which is called “Botarium” (from the expression “Aquarium”, i.e. a container for fish) in order to indicate a means which “encloses” several COMs (communications robots or ComBots). It is assumed that three elements COM1, COM 2, COM3 are allocated to the target entity TE. FIG. 15 shows the view of a display of the target entity TE including the graphic representations of these elements. FIG. 15 furthermore shows a part or a window of the target entity TE which is provided with the reference BOT. This window BOT is the graphic representation of the “Botarium” of the target entity TE.

In order to effect communication between the elements COM1, COM2 and COM3, these elements are placed, copied or moved into the Botarium BOT (e.g. by drag & drop operation). When they are “enclosed” in the Botarium the elements then recognize this situation and exchange information accordingly embedded there. The elements COM1, COM2 and COM3 exchange in particular at least partial information about their profiles among one another or partial information about profiles of those COM elements from which they come. In the last case, if the information has been exchanged, each element COM1, COM2 and COM3 communicates the newly-obtained information to its correspondingly allocated COM element. Such a communication can also be prompted by the corresponding COM by suitable control of the allocated elements.

The affected supplying entities COE1, . . . , COEn are then accordingly supplied with information and/or profiles of the other COMs. As a result, each COM element learns of at least one new COM and thus new contacts and relationships can be set up.

If the COM elements are set up with server support (cf. FIG. 10c) information can also be exchanged between the elements COM1, . . . , COMn by corresponding data transfer, data shift (e.g. between different memory locations etc.) on the affected server(s). The exchange of information affects in particular contact data which are linked to the ComBot in the form of a so-called electronic virtual visiting card (V-Card for short) and which identify the represented user, giving in particular address data, telephone numbers, fax numbers, e-mail addresses etc. The V-Card is thus updated with each modification (change of address of user), wherein the system automatically updates the V-Cards among one another so that each user always has the latest data concerning his contact partners.

The system or at least the user's terminal prompts the elements, i.e. the ComBots or ServiceBots, to exchange specific properties within such a virtual container (“Botarium”) according to the user's presets, by the system operator and/or the offering party. These include graphic design features such as e.g. colour layout, and functional features, such as e.g. animation functions (laughing, crying, . . . ). Thus e.g. ComBot COM1, which is represented by a gold-plated “Mickey Mouse” who can wave a magic wand, can transfer his properties to ComBot COM2, which is represented by e.g. a “Donald Duck”. Donald Duck is likewise gold-plated and receives the “magic wand” accessory and the properties “wave magic wand”. Properties and authorizations of all types can be transferred such as e.g. also access authorities for specific services if these are approved by the provider for transmission. In this connection it is advantageous if the provider defines and provides a Botarium into which only his ServiceBots can be introduced, in order to exchange properties, in particular access authorities.

The invention has been described with reference to so-called ComBots and ServiceBots which represent intelligent contact and communication elements and are suitable in particular for user-friendly direct internet-supported communication between contact partners. However, the invention additionally covers also the most varied communication types and networks to form a communication environment in which users can spontaneously contact each other and communicate directly and securely and have exclusive use of offered services and functions.

1-10. (canceled)

11: A method of setting up a connection in a communication environment controlled by a communication system between a first node allocated to a first contact and a second node allocated to a second contact, the method comprising:
providing a contact element within the first node for the first contact, the contact element having graphic and functional properties and graphically representing the second contact, an unambiguous identification and contact data being allocated to the contact element;
accessing the contact data using a program and setting up a first connection from the first node to the communication system;
checking within the communication system using the unambiguous identification whether the contact element is approved by the communication system for the setting-up of connections; and
setting up a second connection to the second node depending on a result of the checking.

12: The method as recited in claim 11, wherein the connection in the communication environment is a quasi-permanent contact connection.

13: The method as recited in claim 11, wherein the unambiguous identification includes an encrypted serial number.

14: The method as recited in claim 11, wherein the contact element includes a first part and a second part and wherein the graphic properties are defined in the first part and the functional properties are defined in the second part.

15: The method as recited in claim 11, wherein the contact data includes details about at least one of services and functions for the first contact, and further comprising testing within the communication system the details contained in the contact data, and clearing the functions or services for use by the first contact depending on a result of the testing.

16: The method as recited in claim 15, wherein the details includes at least one of communication services and functions provided by the second contact.

17: The method as recited in claim 11, wherein at least the first contact is a user of the communication system, wherein a terminal covered by the first node is allocated to first contact, wherein the program is a user program is run by the user via the terminal in order to set up contact connections with other contacts via the communication system, and wherein the contact element is provided as a program object for the program.

18: The method as recited in claim 17, wherein the program object is in the form of one of a file and a library.

19: The method as recited in claim 11, wherein the second contact is a service provider, wherein the contact data includes details that are predetermined by the service provider, and wherein the second node includes a PC connected to the communication system and allocated to the service provider.

20: The method as recited in claim 19, wherein the PC is a server.

21: The method as recited in claim 20, wherein the contact element is displayed as a graphic element on the terminal of a user, wherein at least one of a graphic design and an animation of the element is predetermined by the service provider.

22: The method as recited in claim 20, wherein several contact elements, each allocated to a different service provider, are provided to the user for selection; and wherein a selected contact element selected by the user is installed on the terminal of the user by a drag & drop operation on the display.

23: The method as recited in claim 22, wherein the display includes a desktop of the terminal.

24: The method as recited in claim 11, wherein the first contact is a first user and the second contact is a second user of the communication system, a first terminal covered by the first node being allocated to the first user and a second terminal covered by the second node being allocated to the second user, wherein the contact element is provided to the first user by the second user, wherein the program is a user program installed on the first terminal and run by the first user in order to set up contact connections with the second user via the communication system, and wherein the contact element is provided as a program object for the program.

25: The method as recited in claim 15, wherein the details contained in the contact data are provided with parameters defining at least one of graphic and functional properties of the contact element.

26: The method as recited in claim 25, wherein the properties include at least one of properties for a graphic design, an animation, a period of validity and an intended use of the contact element.

27: A communication system for controlling a communication environment and the setting-up of a connection in the communication environment between a first node allocated to a first contact and a second node allocated to a second contact, the system comprising:
a data-processing device configured to produce contact elements with graphic and functional properties, each contact element graphically representing one of the first and second contacts at another of the first and second contacts in the form of files, wherein the data-processing device allocates to each contact element an unambiguous identification and contact data;
an administration device configured to provide the first contact with a first contact element graphically representing the second contact and to which an unambiguous identification and contact data are allocated;
a computation device configured to check, using the unambiguous identification, whether the first contact element is an element approved by the communication system for the setting-up of connections; and
a control device configured to control the setting-up of the connection from the first node to the communication system and onward to the second node.

28: The system as recited in claim 27, wherein the connection in the communications environment is a quasi-permanent contact connection.

29: The system as recited in claim 27, wherein the unambiguous identification includes an encrypted serial number.

30: A contact element for setting-up of a connection in a communication environment controlled by a communication system between a first node allocated to a first contact and a second node allocated to a second contact, the contact element comprising:
at least one graphic element for representation on a display of a terminal;
a plurality of functional elements including an unambiguous identification indicating that the contact element is approved for the setting-up of connections in the communication system.

31: The system as recited in claim 30, wherein the display includes a desktop.
